(19) United States
(12) Patent Application Publication
(10) Pub. No.: US 2008/0023038 A1
(43) Pub. Date: Jan. 31, 2008

(54) GRATE CLEANING APPARATUS

(76) Inventor: Alan D. Baldasari, Negaunee, MI (US)

Correspondence Address: BANNER & WITCOFF, LTD., 1100 13th STREET, N.W., SUITE 1200, WASHINGTON, DC, 20005-4051, US

(21) Appl. No.: 11/693,401

(22) Filed: Mar. 29, 2007

Related U.S. Application Data
(60) Provisional application No. 60/786,698, filed on Mar. 29, 2006.

(51) Int. Cl. B08B 9/00

(52) U.S. Cl. 134/22.1; 134/43

(57) ABSTRACT

A mechanical cleaning apparatus and associated method are provided for cleaning the castings of a system, such as a grate-kiln induration system during pelletizing operations. The cleaning apparatus and method can clean castings of the system without adversely affecting their life span through rapid temperature changes or via abrasion to the castings during the cleaning process. The mechanical cleaning apparatus could have raised, narrow sections that are spaced at the same spacing as the slots in the castings to engage the casting surface and the slots under pressure. The sections can drop into the slots during operation of the system to punch out the undesirable build up material in the slots.

### TECHNICAL FIELD

This invention relates generally to a grate cleaning apparatus and to a method for cleaning the castings of pelletizing grate machines. More particularly, the invention concerns an apparatus and method for cleaning the castings on a pelletizing grate machine during normal operation, which may be used with iron ore pelletizing operations.

### BACKGROUND

Pelletizing operations are performed in a variety of industries to form pellets as an end product or for use with other operations. Polymer pelletizing is a process in which a polymer powder is homogenized and addiviated to make pellets. Iron ore processing is a process in which iron ore is taken from the earth, processed into a fine powder, rolled into small round pellets, and reduced in a high temperature process that involves a traveling grate machine and a kiln.

Many pelletizing operations, such as iron ore processing, use grate-kiln induration processes that combine a horizontal traveling grate with a rotating kiln and a cooler so that drying, firing, and cooling are performed separately as iron ore materials travel along the grate. The grates are formed from a series of castings connected to generally form a chain. The castings include slots that permit gases to be blown therethrough, such as heated or cooled air. Over time, the slots become clogged or covered with debris, or can become plugged with cured pellets, which limits the effectiveness of the process. With conventional systems, the castings are cleaned by shutting down the system and cleaning the castings with pressurized water, which results in lost production time and can harm the system.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Aspects of the present invention provide a mechanical cleaning apparatus and associated method for cleaning the castings of a system, such as a grate-kiln induration system during pelletizing operations. A cleaning apparatus and method according to aspects of the invention can clean castings without adversely affecting their life span through rapid temperature changes or via abrasion to the castings during the cleaning process. According to one embodiment of the invention, a mechanical cleaning apparatus has raised, narrow sections that are spaced at the same spacing as the slots in the castings to engage the casting surface and the slots under pressure. The sections can drop into the slots during operation of the grate-kiln induration system to punch out the undesirable build up material in the slots. These and other aspects and features of the invention will be described in greater detail below.

### BRIEF DESCRIPTION OF THE DRAWINGS

FIG. 1 shows a beam support and slide brackets of a grate-cleaning machine according to an example embodiment for illustrating various aspects of the invention.

FIG. 2 shows a bracket and hydraulic cylinder of the grate-cleaning machine of FIG.

FIG. 3 shows a rectangular steel support frame, its connection to a steel support beam, and its support of the cleaning heads of the grate-cleaning machine of FIG. 1.

FIG. 4 shows components of a compression module assembly of the grate-cleaning machine of FIG. 1.

FIG. 5 shows the side view of the grate cleaning machine of FIG. 1.

FIG. 6 shows a cleaning head of a grate-cleaning machine of another example configuration according to embodiments of the invention.

### DETAILED DESCRIPTION OF THE DRAWINGS

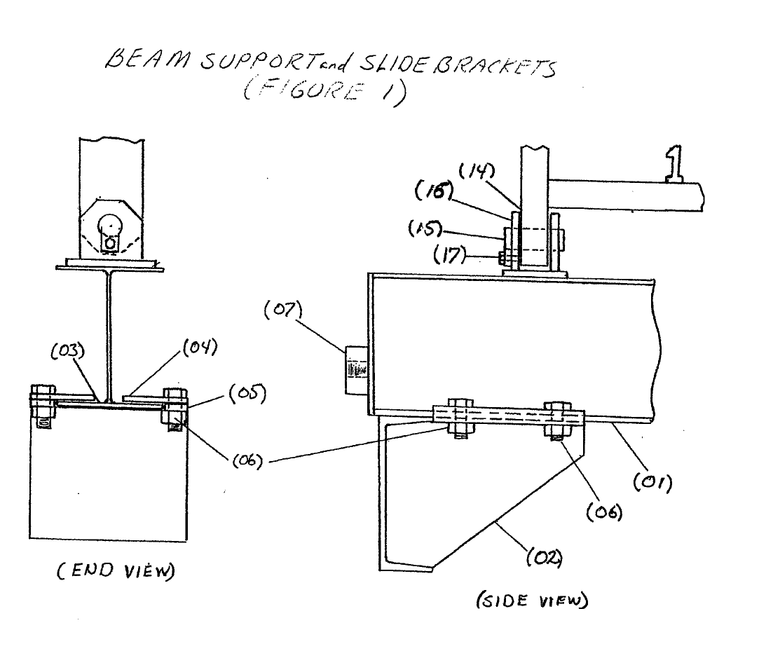

FIGS. 1-6 describe aspects of the invention being used with a conventional grate-kiln induration system for iron ore processing. Portions of the grate-kiln induration system are shown in the figures. Although aspects and embodiments of the invention are described herein in the context of iron ore processing and a conventional grate-kiln induration system, it is understood that the invention can be used with other types of processes and systems. For the conventional grate-kiln induration system discussed herein, a traveling grate machine receives green pellets or (balls) from a roll screen which evenly distributes the green balls across the entire width of the grate. The depth of the pellet (bed) for such a conventional system may vary from 4 to 6 inches depending on the process requirements.

Conventional traveling grate machines can vary in width and length. The smaller the unit the narrower and shorter the machine and generally the shorter the depth of the pellet bed. The larger the unit the wider and longer the machine and the deeper the pellet bed.

The grate machine of the example grate-kiln induration system is basically a giant chain. On a medium sized processing system, this chain can consist of 5 strands of links spaced approximately 35 inches apart. Each endless strand of links can be approximately 200 feet long. The front of each link has a female end and the back of each link has a male end. Each end can have an approximately 1.75″ hole bored through it. With the male and female ends joined long steel rods called (through rods) are inserted through the mated links. This example arrangement forms an endless chain approximately 12′ 6″ wide with the through rods spaced approximately 10 inches on center from each other.

As the example chain is being assembled, an approximately 29″ piece of pipe called a (spacer pipe) is inserted over each through rod as they pass between the rows of links. A machine that has 5 strands of links may have 4 spacer pipes on each through rod. These spacer pipes act as a connection surface for the grate castings.

Each spacer pipe receives along its length 3 castings. Each casting may be approximately 9.575 inches wide and 10 inches long. One end of the casting can have a half round section that fits over the spacer pipe. A clip with a second half round section then attaches to the casting with fasteners. This example configuration allows the casting to swing freely from the spacer pipe and also be securely attached. As the chain comes around the tail sprocket the castings lay flat with the tail or end of each one resting on top of the front portion of the one behind it. This forms a flat continuous surface from side to side and endlessly around the grate chain. This surface is what supports the bed of pellets, such as iron ore pellets.

Doing the math for this example grate-kiln induration system, a grate machine of this size can have approximately 2880 individual castings that form its continuous surface. Each of these castings has 11 rows of slots in its surface. Each slot can be approximately 0.25 inches wide and be spaced approximately 0.810 inches apart on center. These slots allow for super hot preheated air to be forced through them and ultimately through the bed of pellets as they make their journey to the reduction kiln. This preheating process elevates the temperature of the pellets and begins to reduce and ultimately harden them. The grate machine dumps its load of preheated and pre-hardened pellets into the rotary kiln, which finishes the hardening process at a high temperature, such as approximately 2500 degrees F.

As the green pellets are deposited onto the grate machine they are composed of a multitude of raw materials. Raw iron ore, bentonite (clay) which acts as a binder, and limestone (flux) are but a few of the materials that can comprise the bulk of an example iron ore pellet. Certain metallurgical and chemical conditions can come together during the reduction process to cause a build up of undesirable material that plugs the slots in the castings. This build up can come from some of the raw materials that make up the green pellets.

This undesirable build up of material can occur at varying rates, but eventually will result in a significant loss of production from not being able to run at maximum tonnage levels. As the build up gets progressively worse, tonnage through the unit must be cut back because of the negative impact on air flow through the castings. On average, such a conventional grate machine will have to be shut down and cleaned about every 5 weeks.

The conventional cleaning process used to clean the castings of such a grate-kiln induration system has its own negative impact on the system. Because so much revenue is lost during shut down, the unit is cleaned immediately upon being taken down while it is still hot. The temperature of the castings is approximately 500 degrees F. The slots in the castings are cleaned using high pressure water washers, which rapidly cools the castings. This rapid cooling often will result in cracking the castings to effectively reduce their life span.

FIGS. 1-5 show a mechanical grate cleaning apparatus as an example embodiment that illustrates various aspects of the invention. The example mechanical cleaning apparatus not only cleans the castings (on the fly), but also does not negatively affect their life span through unwanted temperature change or abrasion to the castings during the cleaning process. This mechanical cleaning system can be run at the operators' discretion during regular timed intervals or when buildup begins to negatively affect production.

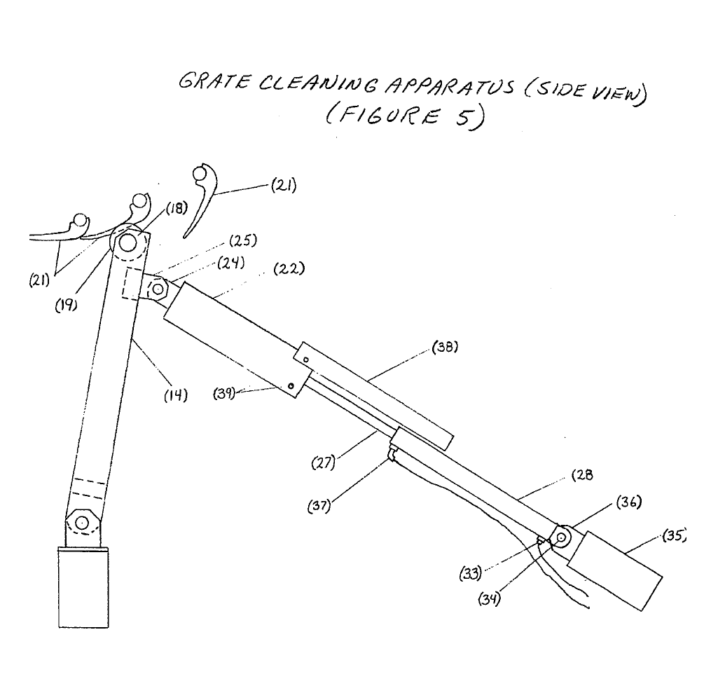

Referring now to FIG. 5, an example grate cleaning machine is shown from a substantially side view. It is shown in its extended position. The cleaning heads that are supported by the rectangular frames are engaged against the castings of the grate machine. The rotary cleaning heads have raised, narrow sections that are spaced at the same spacing as the slots in the castings to engage the casting surface under spring loaded pressure and to subsequently drop into the slots to punch out the undesirable build up material.

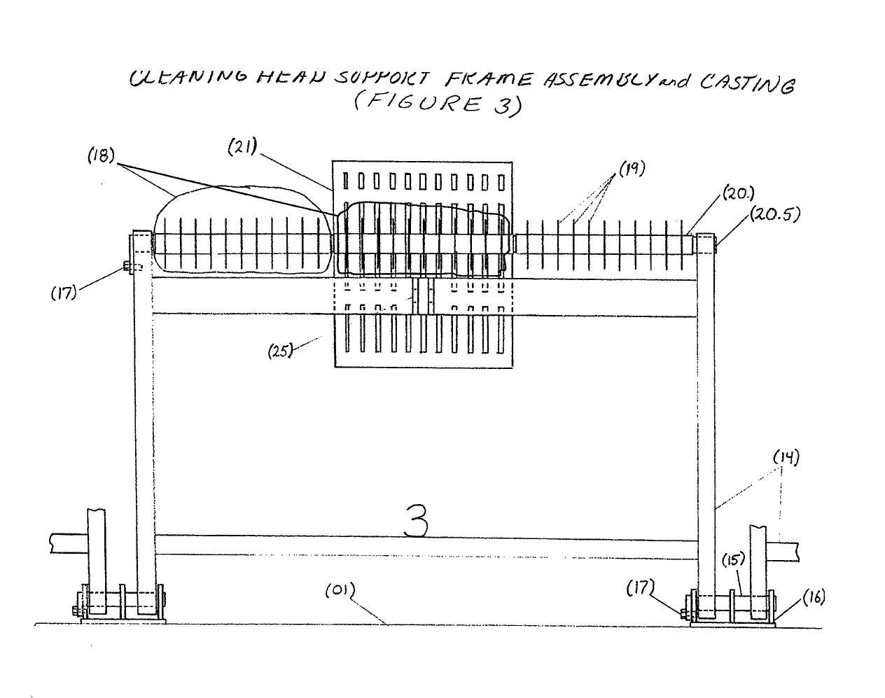

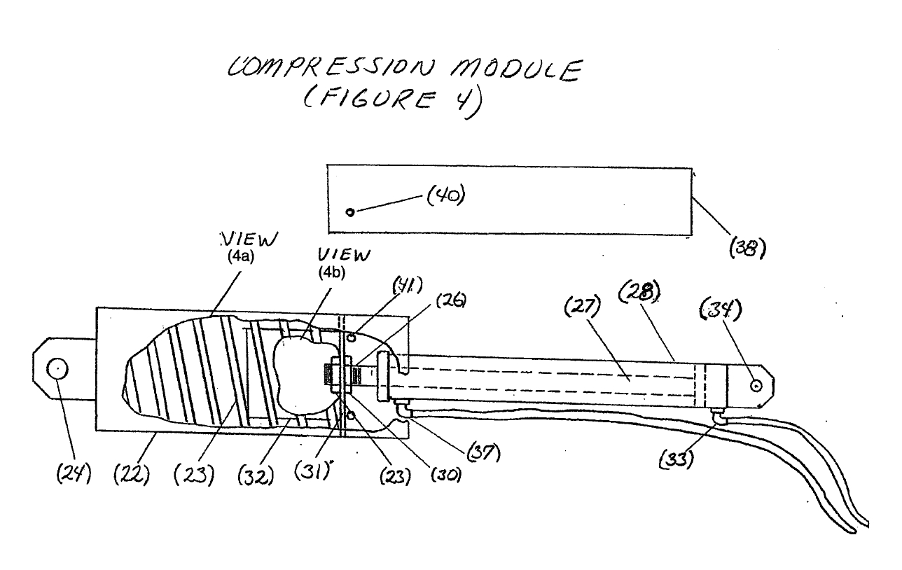

FIG. 1 shows a distal end of support beam 01 resting on top of support bracket 02. The end view shows the lower flange 03 of beam 01 being captured and held loosely in place by slide bracket 04, which sits on top of slide spacer 05 and is held in place by bolts 06. Support beam 01 is limited to movement only in the direction of its length. Support beam 01 is shifted in either direction by hydraulic cylinder 10 shown in FIG. 4. Ram rod of cylinder 10 shown in FIG. 4 is connected to mounting block 07 shown in FIG. 3, which is connected to the distal end of beam 01. This arrangement allows the beam 01 to shift back and forth along its length enabling proper alignment of the cleaning heads to the castings.

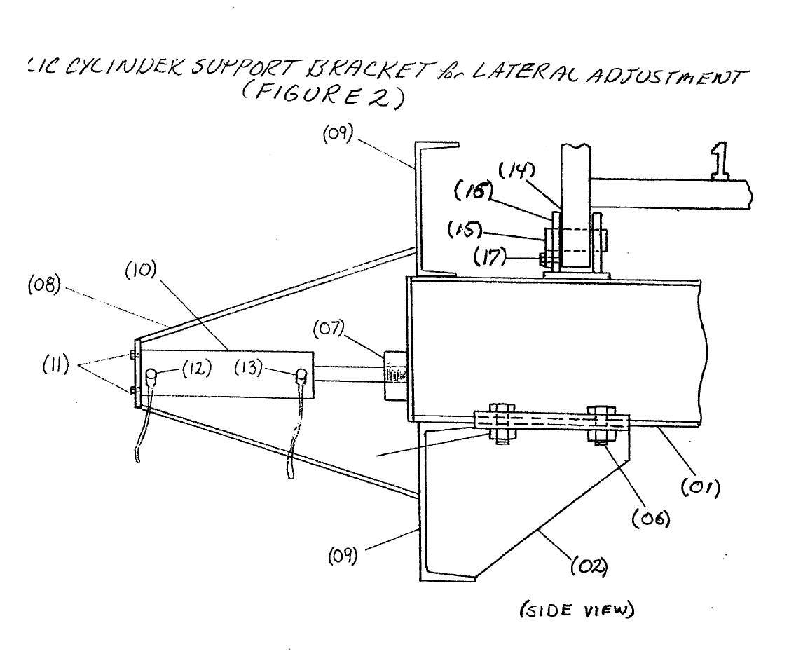

FIG. 2 shows cylinder support bracket 08 attached to structural support 09. Hydraulic cylinder 10 is fastened to the support bracket by bolts 11. Hydraulic hose connections 12 and 13 supply fluid power from a hydraulic pump (not shown) to move beam 01, which is connected to cylinder 10 at ram rod mount 07. Hydraulic cylinder 10 provides the force to shift the steel beam in either direction to position the machine's cleaning heads properly for cleaning out the castings.

FIG. 3 shows the rectangular cleaning head support frame 14 and the lower distal ends of the support frame 14, pinned to beam 01 with pin 15, which forms a pivot point. Pin 15 secures distal end of frame 14 by traveling through bracket 16 which is mounted to beam 01. Pin 15 is secured to bracket 16 by keeper bolt 17. This assembly locks all pins in place on the machine. As shown in FIG. 3, the distal end of the rectangular steel frame 14 supports a steel shaft 20.5. The steel shaft 20.5, in turn, supports rotary cleaning heads 18 by passing through a bore at the center of each cleaning head. These cleaning heads ride against the castings surface and effectively remove unwanted build up.

As shown in FIG. 3, washers 19 on cleaning head 18 can be stacked at even intervals along tube 20 and welded in place. In another configuration, cleaning head 18 could also be machined from a solid piece of material to form the cleaning heads on a shaft. Washers 19 are spaced to line up with slots in casting 21. Intrusion of the washers 19 into the casting slots under pressure removes the unwanted build up of material.

FIG. 4 shows a detailed drawing of the coil spring compression module that provides the biasing force to the cleaning head. The compression module generally includes a large contained coil spring that is activated and compressed by the actuation of a fluid hydraulic cylinder to force the cleaning frame, which supports the cleaning heads, against the continuous casting surface. The coil spring allows the narrow raised sections (e.g., washer edges) of the cleaning head to drop into the slots on the castings to remove material and to allow the cleaning head to ride up and over the casting surface between the slots.

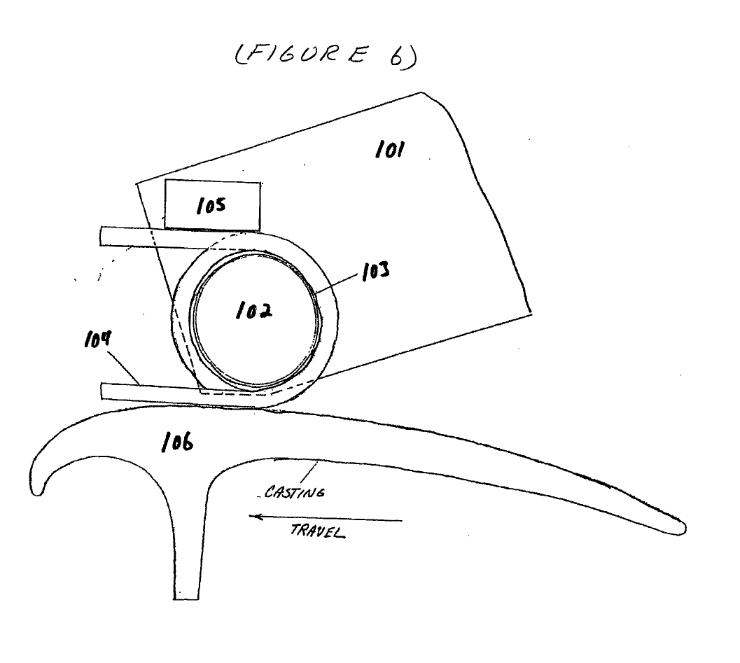

As shown in cutaway view 4a of FIG. 4, tube 22 contains coil spring 23 and is disposed about the outer diameter of spring 23. Tube 22 is pinned at mounting point 24 to rectangular frame 14 at its mounting point 25 (see FIG. 6). In second cutaway view 4b of FIG. 4, distal threaded end 26 of ram 27 contained in hydraulic cylinder 28 is secured by nuts 29 and 30 to plate 31. Plate 31 is round having an outer diameter slightly smaller than the inside diameter of tube 22. Plate 31 has a short round tube 32 welded to it. The outside diameter of tube 32 is slightly smaller than the inside diameter of coil spring 23. When the hydraulic pump supplies fluid pressure to fitting 33 of cylinder 28, ram 27 is pushed out of cylinder 28 and begins to increase the distance between tube 22's mounting point 24 and cylinder 28's mounting point 34. Cylinder 28's mounting point is pinned to support beam 35 at mount 36 in FIG. 5. Plate 31's outer edge catches and supports the end of spring 23 shown in FIG. 4.

As shown in FIG. 5, when cleaning heads 18 contact casting surface 21, coil spring 23 inside tube 22 compresses to apply pressure between cleaning heads 18 and casting surface 21. With hydraulic fluid flow stopped and coil spring 23 in a partially compressed state, washers 19 on cleaning head 18 shown in FIG. 3 are able to drop into the slots on casting 21 during spring 23's extension and to ride up and out of the slots on casting 21 during spring 23's compression. To return rectangular frame 14 and cleaning heads 18 to their resting unengaged position, hydraulic fluid flow is reversed and supplied to fitting 37 on cylinder 28. This forces ram 27 back into cylinder 28, which decreases the distance between tube 22's mount point 24 and cylinder 28's mount point 34.

As shown in FIGS. 7 and 8, cylinder 28 is shielded from falling objects by guard 38. Guard 38 is fastened to tube 22 with fastener 39. Fastener 39 also acts as a stop to prevent plate 31 from pulling out of tube 22.

It is understood that other configurations may be used with the cleaning system of FIGS. 1-5 to provide a biasing force to the cleaning head or to provide alternative slot-engaging members to engage the slots under bias. For example, the coil spring of the compression module could be replaced with a pressurized air bladder or constant force gas spring to effectively apply pressure at the cleaning point of contact while allowing “give” in the system.

FIG. 6 shows another example configuration of a cleaning head having alternative slot-engaging members. In the configuration of FIG. 6, small alloy torsion springs or slot-engaging members substitute for the rotary cleaning heads of the grate cleaning machine of FIGS. 1-5. The slot-engaging members drag against the casting surface in a compressed condition with stored energy, which, in this example, is provided by torsion springs. As the distal end of the spring or other slot-engaging member encounters a slot, it would release its energy or otherwise moves under bias to plunge into the slot and removing the build up therein.

As shown in FIG. 6, a distal end of the support frame 101 houses support shaft 102 through bore 103. Support shaft 102 carries a row of torsion springs 104. The distal end of torsion spring 104 is held in place by stop bar 105. As support frame 101, shaft 102, and torsion springs 104 engage casting 106, the other distal end of torsion spring 104 is forced into a compressed or energized state. As the compressed distal end of torsion spring 104 encounters a casting slot, it springs into the opening to release its energy and clear the opening of unwanted buildup.

While the present invention has been described in connection with the illustrated embodiments, it will be appreciated and understood that modifications may be made without departing from the true spirit and scope of the invention. In particular, the invention applies to any mechanical machine that physically removes unwanted build up material from the slots in the castings of a pelletizing grate machine.

I claim:

1. A grate cleaning machine comprising:
one or more bias members; and
a plurality of slot-engaging members connected to the one or more bias members and biased toward engagement with corresponding slots formed in the castings of a pelletizing grate machine.

2. The grate cleaning machine of claim 1, wherein the one or more bias members include a hydraulically actuated coil spring compression module.

3. The grate cleaning machine of claim 1, further comprising:
a frame having a first end and an opposite second end, the first end pivotally connected to a rigid support; and
a shaft disposed at the second end of the frame, the shaft supporting the plurality of slot-engaging members.

4. The grate cleaning machine of claim 3, wherein the slot-engaging members include washers disposed on the shaft.

5. The grate cleaning machine of claim 3, wherein the slot-engaging members include torsion springs disposed on the shaft.

6. The grate cleaning machine of claim 3, wherein the second end of the frame is connected to the one or more bias members.

7. The grate cleaning machine of claim 6, wherein the one or more bias members include a hydraulically actuated coil spring compression module pivotally connected to a rigid support at a first end thereof and pivotally connected to the second end of the frame at a second end thereof.

8. A method of cleaning a pelletizing grate machine, the method comprising while the pelletizing grate machine is performing pelletizing operations, mechanically engaging slots formed in a casting of the pelletizing grate machine to dislodge build up material in the slots.
